(19) United States
(12) Patent Application Publication
(10) Pub. No.: US 2012/0034023 A1
(43) Pub. Date: Feb. 9, 2012

(54) Telescopic Apparatus

(76) Inventors: Kun-Jie WANG, Taichung City (TW); Rong-Jin Liang, Taichung City (TW); David Tsai, Taichung City (TW)

(21) Appl. No.: 12/853,286

(22) Filed: Aug. 9, 2010

(51) Int. Cl. F16B 7/10

(52) U.S. Cl. 403/109.3

(57) ABSTRACT

A telescopic apparatus includes an internal tube telescopically inserted in an external tube. The internal tube includes depressions defined therein. A frame is secured to the external tube. A lever is pivotally connected to the frame. The lever includes a space transversely defined therein, a groove in communication with and in parallel to the space, and a pawl for insertion in a selected one of the depressions for locking the internal tube relative to the external tube. A spring is substantially located in the space. The spring includes a hook for hooking the frame and a bent section located in the groove. A short tube is located in the space and against the spring. A screw is inserted through the frame, the spring and the short tube. A security unit is movably connected to the frame between a locking position against the lever to avoid pivoting of the lever and a releasing position away from the lever to allow pivoting of the lever.

### BACKGROUND OF THE INVENTION

1. Field of the Invention

The present invention relates to a telescopic apparatus and, more particularly, to a control unit operable to allow and avoid changes in the effective length of the telescopic apparatus.

2. Description of the Prior Art

As disclosed in U.S. Pat. No. 6,247,882 issued to the present applicant, a conventional telescopic apparatus includes a rod 10 telescopically inserted in a tube 20. The rod 10 includes depressions 12 defined therein. Changes in the effective length of the conventional telescopic apparatus are under the control of a control unit. The control unit includes a sleeve 30, a lever 35, a spring 39, a blade 40 and a shaft 50. The sleeve 30 is secured to the tube 20. The sleeve 30 includes a pair of flaps 32 in parallel to each other.

The blade 40 includes two ears 41 each inserted through an aperture 36 defined in a related one of the flaps 32. The blade 40 includes a projection 42 extending from a side thereof and a bulge 43 extending from an opposite side thereof for insertion in a selected one of the depressions 12.

The shaft 50 is movably inserted through an aperture 37 defined in one of the flaps 32 and an aperture 38 defined in the other flap 32. A nut 55 is engaged with the shaft 50. The shaft 50 is in the form of a screw with sections of different diameters. The shaft 50 includes two grooves 54 defined in and around the periphery. A selected one of the grooves 54 receives the extension 42.

The lever 35 includes a pawl 80 extending from an end for insertion in a selected one of the depressions 12 to retain a value of the effective length of the conventional telescopic apparatus. The lever 35 is pivotally connected to the flaps 32 by a pin 34.

The spring 39 includes a helical section extending between two rectilinear sections. The helical section of the spring 39 is pivotally located around the pin 34. One of the rectilinear sections of the spring 39 is located against the blade 40 while the other rectilinear section of the spring 39 is located against the lever 35.

When a larger one of the sections of the shaft 50 is located against the lever 35, the lever 35 cannot be pivoted and the pawl 80 cannot be removed from the selected depression 12. Hence, the effective length of the conventional telescopic apparatus is retained. The projection 42 is located in one of the grooves 54. When a smaller one of the sections of the shaft 50 is located below the lever 35, the lever 35 can be pivoted and the pawl 80 can be removed from the selected depression 12. Hence, the effective length of the conventional telescopic apparatus can be changed. The projection 42 is located in the other groove 54.

There are however some problems with the conventional telescopic apparatus. At first, the gap between the lever 35 and the blade 40 is too small to encompass the spring 39 to facilitate the insertion of the pin 34 through the helical section of the spring 39. Secondly, the insertion of the shaft 50 into the flaps 32 and the removal of the former from the latter are hindered by the insertion of the projection 42 in a selected one of the grooves 54. Thirdly, it takes quite some time for a user to use a hand to hold the shaft 50 and the other hand to operate a tool to rotate the nut 55 to engage the nut 55 with the shaft 50.

Therefore, the present invention is intended to obviate or at least alleviate the problems encountered in prior art.

### SUMMARY OF THE INVENTION

The primary objective of the present invention is to provide an telescopic apparatus that can be made and used easily.

To achieve the foregoing objective, the telescopic apparatus includes an internal tube telescopically inserted in an external tube. The internal tube includes depressions defined therein. A frame is secured to the external tube. The frame includes two walls in parallel to each other. A lever is pivotally connected to the walls. The lever includes a space transversely defined therein, a groove in communication with and in parallel to the space, and a pawl for insertion in a selected one of the depressions for locking the internal tube relative to the external tube. A spring is substantially located in the space. The spring includes a hook for hooking one of the walls and a bent section located in the groove. A short tube is located in the space and against the spring. A screw is inserted through the walls, the spring and the short tube. A security unit is movably connected to the walls between a locking position against the lever to avoid pivoting of the lever and a releasing position away from the lever to allow pivoting of the lever.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a telescopic apparatus in accordance with the preferred embodiment of the present invention;

FIG. 2 is a partial, cross-sectional view of the telescopic apparatus shown in FIG. 1;

FIG. 3 is a partial, exploded view of the telescopic apparatus of FIG. 1;

FIG. 4 is another partial, cross-sectional view of the telescopic apparatus shown in FIG. 1;

FIG. 5 is another partial, cross-sectional view of the telescopic apparatus shown in FIG. 1; and

FIG. 6 is another partial, cross-sectional view of the telescopic apparatus shown in FIG. 1.

### DETAILED DESCRIPTION OF THE PREFERRED EMBODIMENT

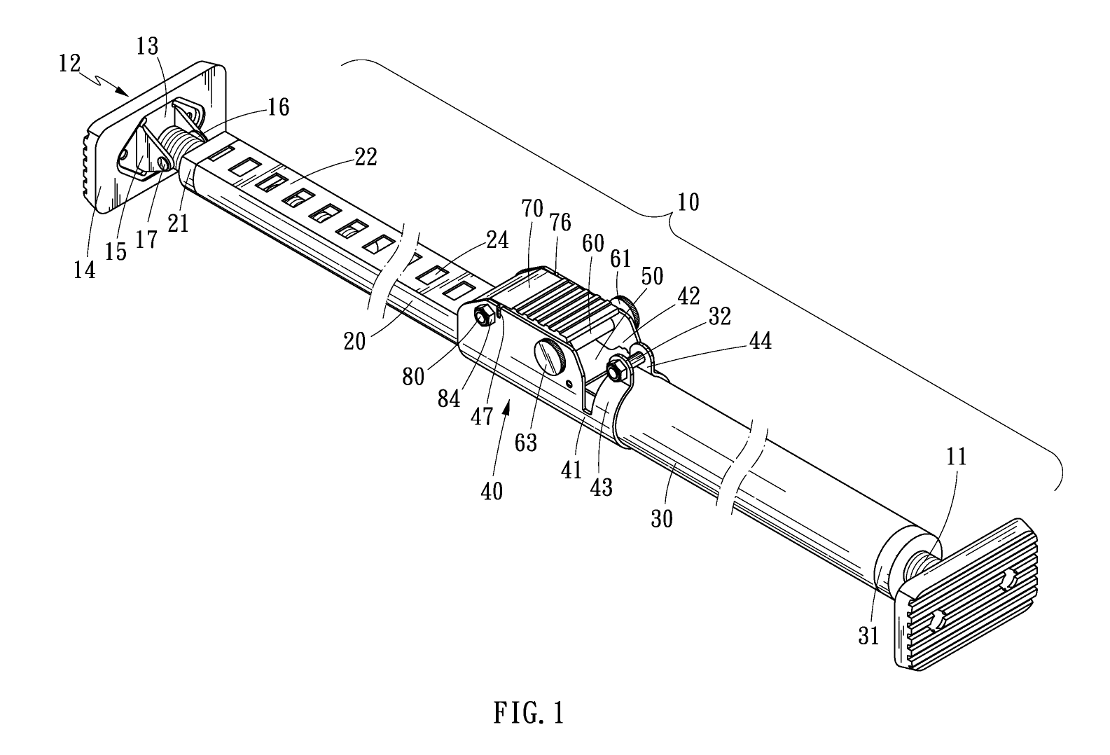

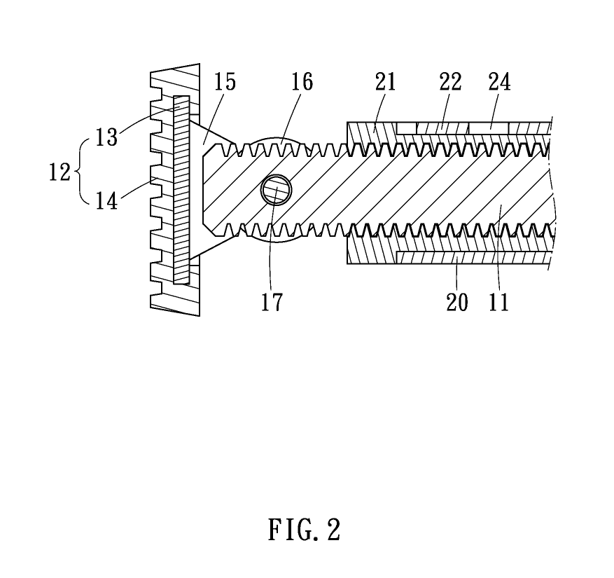

Referring to the drawings and initially to FIGS. 1 and 2, a telescopic apparatus includes an internal tube 20 telescopically inserted in an external tube 30 in accordance with the preferred embodiment of the present invention. The internal tube 20 includes several depressions 24 defined in a flat side 22 formed thereon.

A contact unit 12 is pivotally connected to an end of each of the tubes 20 and 30. To this end, a plug 21 is fit in the end of the internal tube 20, and a plug 31 is fit in the end of the tube 30. A screw 11 is driven in each of the plugs 21 and 31. The contact unit 12 includes a plate 13 substantially covered by a protective layer 14. The plate 13 is preferably made of metal while the protective layer 14 is preferably made of rubber or plastics. The plate 13 includes two ears 15 extending from a side. The ears 15 are not covered by the protective layer 14. The ears 15 are pivotally connected to the screw 11 by a fastener 17 such as a screw and a rivet. A washer 16 may be provided on the fastener 17.

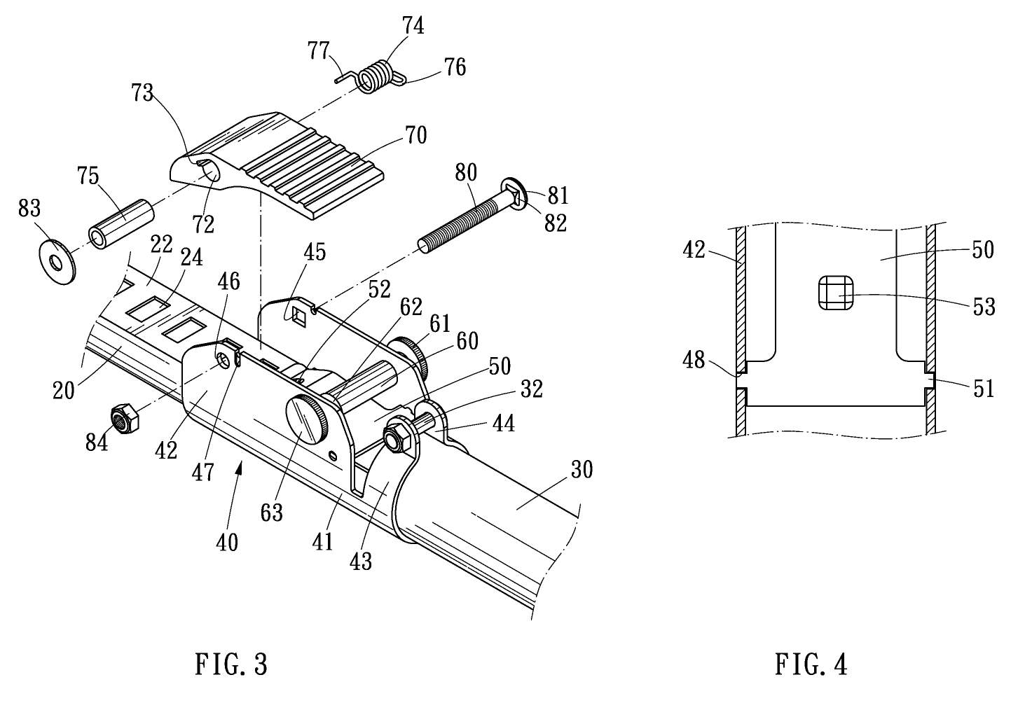

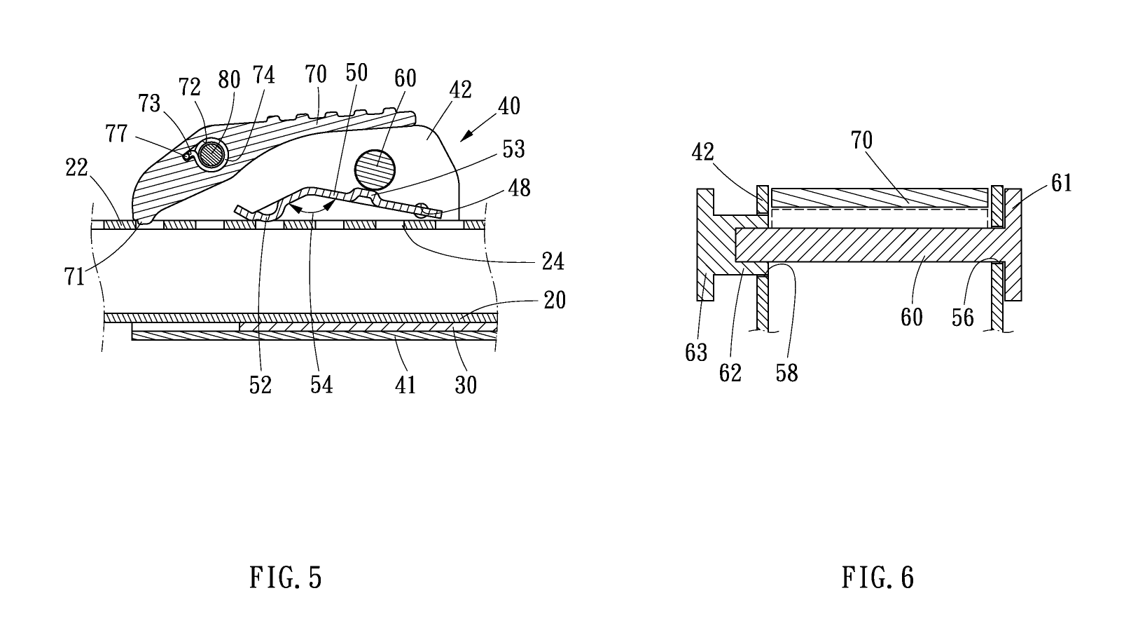

Referring to FIGS. 3 through 6, changes in the effective length of the telescopic apparatus are under the control of a control unit 40. The control unit 40 includes a frame 41, a leaf 50, a security unit, a lever 70 and a screw 80. The frame 41 includes two walls 42 in parallel to each other. The frame 41 is formed with a brace 43 that includes two jaws 44. The frame 41 is provided on the external tube 30. The external tube 30 is located between the walls 42. The external tube 30 is located between the jaws 44 of the brace 43. A screw 32 is driven through the jaws 44 before it is engaged with a nut. Thus, the frame 41 is secured to the external tube 30. A square aperture 45 is defined in one of the walls 42 while a circular aperture 46 is defined in the other wall 42. A cutout 47 is defined in an edge of each of the walls 42. An aperture 48 is defined in each of the walls 42. An aperture 56 is defined in one of the walls 42 while an aperture 58 is defined in the other wall 42. The size of the aperture 56 is smaller than that of the aperture 58.

The leaf 50 is made with elasticity. The leaf 50 is preferably a leaf spring made of metal. The leaf 50 includes two pivots 51 laterally extending from an end, a first bulge 52 formed on a side, and a second bulge 53 formed on an opposite side. Each of the pivots 51 is inserted through the aperture 48 defined in a related one of the walls 42 for pivotally connecting the leaf 50 to the walls 42. The first bulge 52 can be inserted in a selected one of the depressions 24. The second bulge 53 is located closer to the pivots 51 than the first bulge 52 is. The leaf 50 is made with a bent configuration including two sections, with an angle 54 defined between the sections.

The lever 70 includes a pawl 71 extending from an end, a space 72 defined therein transversely, and a groove 73 defined therein transversely. The space 72 is in communication with the groove 73. The axis of the space 72 is in parallel to the length of the groove 73.

There are provided a spring 74 and a short tube 75. The spring 74 is a torque spring with a helical section extending between a hook 76 and a bent section 77.

The screw 80 includes a generally circular head 81, a square block 82 and of course a thread. The square block 82 is located between the head 81 and the thread. The diameter of the circular head 81 is larger than the dimension of the sides of the square block 82.

Both of the spring 74 and the short tube 75 are located in the space 72 before the lever 70 is located between the walls 42. The helical section of the spring 74 is located in the space 72 while the bent section 77 is located in the groove 73. The hook 76 is located in the cutout 47 defined in a selected one of the walls 42. The threaded section of the screw 80 is inserted through the square apertures 45, the helical section of the spring 74, the short tube 75, a washer 83 and the circular aperture 46. The square block 82 is located in the square aperture 45. Thus, the screw 80 cannot be rotated relative to the frame 41. The screw 80 is engaged with a nut 84. Thus, the lever 70 is pivotally connected to the frame 41. The lever 70 is biased toward the internal tube 20 because of the spring 74. The engagement of the screw 80 with the nut 84 is easy because the screw 80 cannot be rotated relative to the frame 41.

The security unit includes a pin 60 engaged with a cap 62. The pin 60 includes is formed with a head 61. The cap 62 is formed with a head 63 identical to the head 61. The pin 60 is movably located in the aperture 56 while the cap 62 is movably located in the aperture 58. The pin 60 is fit in the cap 62. To enhance the connection of the pin 60 to the cap 62, an adhesive material may be provided between them. The connection of the pin 60 to the cap 62 is easy. The pin 60 can be replaced with a screw while the cap 62 can be replaced with a nut in another embodiment.

In use, the pawl 71 is located in a selected one of the depressions 24. The cap 62 is located against the lever 70. Thus, the lever 70 cannot be pivoted. The pawl 71 is retained in a selected one of the depressions 24 to lock the internal tube 20 relative to the external tube 30, i.e., the effective length of the telescopic apparatus is retained. The first bulge 52 is located in a selected one of the depressions 24. The pin 60 is located against the second bulge 53.

To change the effective length of the telescopic apparatus, the security unit is operated so that the cap 62 is not located against the lever 70. The lever 70 is pivoted, and the pawl 71 removed from the selected depression 24. Hence, the internal tube 20 can be moved relative to the external tube 30, i.e., the effective length of the telescopic apparatus can be changed. Because of the elasticity of the leaf 50, the first bulge 52 can be removed from one of the depressions 24 and inserted in another one of the depressions 24, and clicks are made.

The telescopic apparatus of the present invention exhibits several advantages over the one disclosed in U.S. Pat. No. 6,247,882. At first, it is easy to insert the screw 80 through the helical section of the spring 74 and the short tube 75, which are located in the space 72. Secondly, the insertion of the security unit through the walls 42 and the removal of the former from the latter are easy since the security unit consists of two elements that are made separately and later joined together. At last, the engagement of the nut 84 with the screw 80 is easy because the screw 80 cannot be rotated relative to the frame 41 when the square block 82 is located in the square aperture 45.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

I claim:

1. A telescopic apparatus including:
an external tube;
an internal tube telescopically inserted in the external tube, wherein the internal tube includes depressions defined therein;
a frame secured to the external tube;
a lever pivotally connected to the frame, wherein the lever includes a space transversely defined therein, a groove in parallel to and in communication with the space, and a pawl for insertion in a selected one of the depressions for locking the internal tube relative to the external tube;
a spring substantially located in the space, wherein the spring includes a hook for hooking the frame and a bent section located in the groove;
a short tube located in the space and against the spring;
a screw inserted through the frame, the spring and the short tube; and
a security unit movably connected to the frame between a locking position against the lever to avoid pivoting of the lever and a releasing position away from the lever to allow pivoting of the lever.

2. The telescopic apparatus according to claim 1, wherein the frame includes two walls in parallel to each other.

3. The telescopic apparatus according to claim 2, wherein the lever is pivotally connected to the walls.

4. The telescopic apparatus according to claim 2, wherein the hook hooks one of the walls.

5. The telescopic apparatus according to claim 2, wherein the screw is inserted through the walls.

6. The telescopic apparatus according to claim 2, wherein the security unit is movably connected the walls.

7. The telescopic apparatus according to claim 2, further including a leaf pivotally connected to the walls, wherein the leaf includes a first bulge extending from a side for insertion in a selected one of the depressions.

8. The telescopic apparatus according to claim 7, wherein the leaf includes a second bulge extending from an opposite side for abutment against the security unit.

9. The telescopic apparatus according to claim 2, wherein the screw includes a head formed at an end and a square block formed next to the head, wherein one of the walls includes square aperture for receiving the square block while the other wall includes a circular aperture for receiving the screw.

10. The telescopic apparatus according to claim 2, wherein the security unit includes a pin and a cap for receiving a section of the pin, wherein one of the walls includes an aperture for receiving the pin while the other wall includes an aperture for receiving the cap.

11. The telescopic apparatus according to claim 1, further including a contact unit pivotally connected to each of the internal and external tubes.

12. The telescopic apparatus according to claim 11, wherein the contact unit includes a plate pivotally connected to each of the internal and external tubes and a protective layer for covering the plate.

13. The telescopic apparatus according to claim 12, wherein the plate includes two ears pivotally connected to each of the internal and external tubes.

14. The telescopic apparatus according to claim 13, wherein the contact unit further includes a screw driven in each of the internal and external tubes, wherein the ears are pivotally connected to the screw.

15. The telescopic apparatus according to claim 14, wherein the contact unit further includes a plug fit in each of the internal and external tubes, wherein the screw is driven in the plug.
